(19) United States
(12) Patent Application Publication
(10) Pub. No.: US 2015/0020907 A1
(43) Pub. Date: Jan. 22, 2015

(54) Water outlet for a sanitary system of a rail vehicle

(71) Applicant: SIEMENS AKTIENGESELLSCHAFT, Muenchen (DE)

(72) Inventors: Patrick Ehrke, Voigtsbruegge (DE); Rainer Wiegner, Spenge (DE)

(21) Appl. No.: 14/374,955

(22) PCT Filed: Dec. 12, 2012
(86) PCT No.: PCT/EP2012/075151

§ 371 Date: Jul. 28, 2014

(30) Foreign Application Priority Data
Jan. 26, 2012 (DE) 10 2012 201 146.3

(51) Int. Cl. F16L 53/00

(52) U.S. Cl. CPC F16L 53/008
USPC 138/33

(57) ABSTRACT

A water outlet for a sanitary system on a rail vehicle includes a water outlet pipe and a heating device for protecting the water outlet pipe from frost. The heating device is guided from outside into an end piece of the water outlet pipe and therefore is at least partially arranged in the interior space of the end piece.

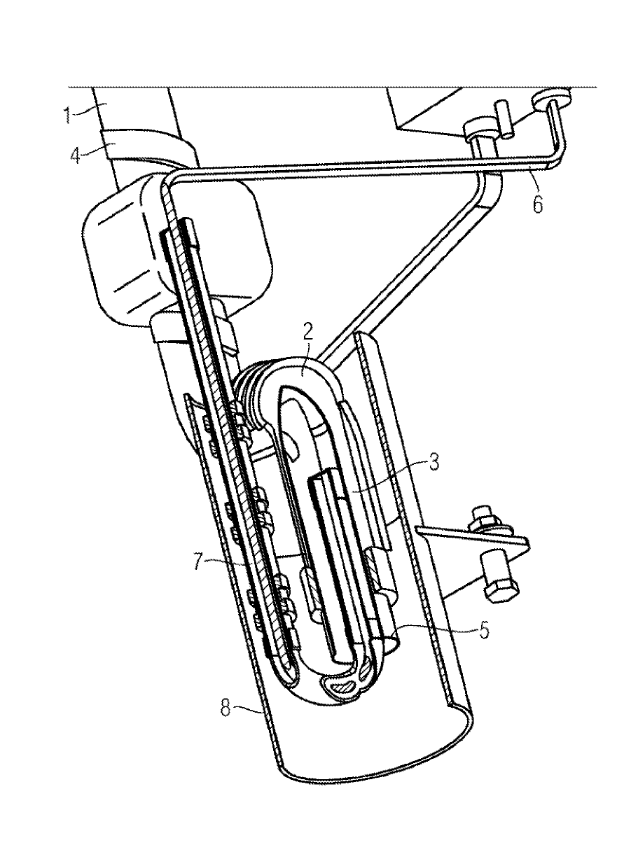

The invention relates to a water outlet for a sanitary system of a rail vehicle, comprising a water outlet pipe and a heating device for protecting the water outlet pipe from frost.

In trains traveling long and short distances, sanitary systems, such as, for example, a WC-facility, are generally made available to the passengers. Owing to hygiene requirements, such sanitary systems are equipped with a hand wash basin. The sanitary units installed in trains then have a hand wash basin which provides fresh water and, for example, liquid soap. The used, weakly contaminated hand wash water, which is also referred to as gray water, is either channeled into a wastewater tank or discharged to the track bed with the aid of a water outlet pipe.

Where the water is discharged to the track bed, for example in the case of high-speed rail vehicles, such as in the Velaro Rus, Velaro CRH 3, or Velaro-Plattform, such gray water outlets as they are known are situated at the carriage end in the underfloor region in the vicinity of the bogies.

The underfloor region in the vicinity of the bogies is, for example, subjected to particularly high mechanical loading by stone impact. As a result, thermal insulation of the water outlet pipe and pipe trace heating around the outside of the water outlet pipe are very frequently damaged.

This promotes ice formation caused by discharged gray water and drifting snow, resulting in further mechanical loading of the thermal insulation. Manual deicing of gray-water pipe openings by service personnel has the effect that the thermal insulation is frequently additionally damaged and possibly partially torn off in the region of the water outlet.

The causes such as lack of thermal insulation and damaged/failed heating elements lead to an increased extent to the failure of the sanitary system in the case of severe frost since the end piece of the water outlet pipe freezes over.

On this basis, the object on which the invention is based is to further develop a water outlet for a sanitary system of a rail vehicle of the initially stated type in such a way that improved protection against freezing over is obtained.

This object is achieved in the case of the water outlet in that the heating device is routed from outside into an end piece of the water outlet pipe and is thus at least partially arranged in the interior of this end piece. The heating device provided serves as a heat source which intensifies an ice-channel forming effect. Even in the case of severe minus temperatures, this effect can be further maintained. The heating element situated at least partially in the interior of the end piece of the water outlet pipe keeps a channel free in this region, resulting in reliable frost protection for the water outlet.

The heating device is preferably of strip-shaped design and is routed in a pipe in the region of the end piece. In principle, a strip-shaped heating device can be used flexibly. Its routing in a pipe makes it possible for the heating device to be arranged at least partially in the interior of the end piece of the water outlet pipe in order to achieve the desired frost protection purpose.

The heating device can preferably be routed out of the end piece of the water outlet pipe initially in a curve and then along the outside of the end piece. In this way, a favorable mounting for the heating device and also its electrical connection can be achieved.

The water outlet pipe is preferably sheathed by insulating material which counteracts a freezing-over of the end piece of the water outlet pipe.

In order to further increase the frost protection properties of the water outlet pipe, the end piece of the water outlet pipe can be enclosed by a wind guard. This measure also has the effect, without interacting with the heating device routed into the interior of the end piece, that it is made more difficult for the end piece of the water outlet pipe to freeze over. Here, the wind guard acts in such a way that cold relative wind which occurs cannot act in an unrestricted manner on the temperature of the end piece. Given an appropriate selection of material, for example stainless steel, the wind guard additionally serves as protection against stone impact.

The wind guard is preferably of tubular design and is thus matched in terms of its outer design to the end piece of the water outlet pipe. The thermal insulating material, where provided, is then situated between the wind guard and the end piece of the water outlet pipe.

A favorable mode of operation of the wind guard is afforded when the latter extends beyond the end piece. Favorable properties then result to the effect that suitable stone protection is achieved and also the thermal effect of cold relative wind is reduced.

In addition, a strip-shaped heating element can be wound around the water outlet pipe. In the case when both the heating device routed into the interior of the end piece and the strip-shaped heating element wound from outside are provided, said heating element will be situated only along the water outlet pipe outside the end piece.

An exemplary embodiment of the invention will be explained in more detail below with reference to the drawings. The individual FIGURE shows a perspective view, partially in section, of a water outlet for a sanitary system of a rail vehicle.

The water outlet for a sanitary system of a rail vehicle as illustrated in the FIGURE can be arranged, for example, in a carriage end in the underfloor region in the vicinity of the bogies of a rail vehicle and serves for discharging gray water which arises when using the sanitary system in question, for example a hand wash basin. Here, a water outlet pipe 1 coming from a carriage side merges, behind a bend 2, into a straight end piece 3 of the water outlet. In order to heat the pipeline 1, use is made of a strip-shaped heating device 4 which is wound along the pipeline 1 and, if possible beyond the bend 2, up to the water outlet pipe end 5 about the pipeline 1.

Moreover, the pipeline 1 and the end piece 3 are surrounded by insulating material, not represented in the FIGURE for reasons of clarity, which extends up to a free end 5 of the end piece 3.

To protect the water outlet from frost, a further electrical heating device is provided which comprises a strip-shaped heating element 6. This strip-shaped heating element 6 is routed such that it projects from the free end 5 of the end piece 3 into the interior of the end piece 3. For this purpose, the strip-shaped heating element 6 is routed in a copper pipe 7 approximately in the region of the end piece 3, which pipe initially extends substantially parallel to the end piece 3, is subsequently bent in an approximate U-shape and is then routed into the interior of the end piece 3.

With the aid of the strip-shaped heating element 6 routed partially in the copper pipe 7, an ice channel is formed within the end piece 3 when the water outlet is subjected to frost. Also contributing to frost protection is the insulating material already mentioned above, which insulating material is arranged in the region of the end piece 3 between the copper pipe 7 and the end piece 3 itself and completely sheaths the end piece 3.

To further increase the frost protection of the water outlet, use is made of a wind guard 8 produced, for example, from steel pipe, the inside diameter of which is dimensioned such that the arrangement of strip-shaped heating element 6 and copper pipe 7 in the region of the end piece 3 can be arranged inside the wind guard 8. The wind guard 8 forms both protection against cold relative wind and impact protection with respect to swirled-up stones or the like. In this respect, the wind guard 8 acts as mechanical protection for the insulation in which the end piece 3 is sheathed, but also for the copper pipe 7.

It should be emphasized that the water outlet can, for example, also be a fresh water overflow. This can be combined with a condensation water outflow of an air-conditioning unit.

Particularly in cases in which a wind protection for the end piece 3 is already provided by other underfloor components, the wind guard 8 can also function exclusively as a protective collar.

1-8. (canceled)

9. A water outlet for a sanitary system of a rail vehicle, the water outlet comprising:
a water outlet pipe having an end piece; and
a heating device for protecting the water outlet pipe against freezing, said heating device being routed from outside into said end piece of said water outlet pipe and being disposed at least partially in an interior of said end piece of said water outlet pipe.

10. The water outlet according to claim 9, wherein said heating device comprises a strip-shaped heater routed inside a pipe in a region of said end piece.

11. The water outlet according to claim 9, wherein said heating device is routed out of said end piece initially along a curve and then along an outside of said end piece.

12. The water outlet according to claim 9, which comprises insulating material sheathing said water outlet pipe.

13. The water outlet according to claim 9, which comprises a wind guard enclosing said end piece of said water outlet pipe.

14. The water outlet according to claim 13, wherein said wind guard is tubular.

15. The water outlet according to claim 13, wherein said wind guard extends beyond said end piece.

16. The water outlet according to claim 9, which comprises a strip-shaped heating element wound around said water outlet pipe leading up to a water outlet pipe end.
